(19) United States
(12) Patent Application Publication
(10) Pub. No.: US 2004/0197551 A1
(43) Pub. Date: Oct. 7, 2004

(54) Sprayable hardtop coating

(76) Inventors: John Paul Simmons, Farmington Hills, MI (US); Timothy C. Price, Macomb, MI (US)

Correspondence Address: Miller, Canfield, Paddock and Stone P.L.C., c/o Robert Kelley Roth, Suite 2500, 150 West Jefferson Ave., Detroit, MI, 48226, US

(21) Appl. No.: 10/404,158

(22) Filed: Apr. 1, 2003

(51) Int. Cl. B32B 1/00

(52) U.S. Cl. 428/332; 106/31.57

(57) ABSTRACT

A coating suitable for spraying onto a substrate comprises a gel coat and a filler. Preferably the weight of filler exceeds the weight of the gel coat. Preferably the filler is unground, that is, no secondary grinding operation is required to be performed on the filler prior to mixture with the gel coat. Preferably the coating has less than 17.5% by weight reactive monomer.

### FIELD OF THE INVENTION

This invention relates to improvements to sprayable coatings, and, more particularly, to a sprayable coating suitable for forming a hardtop on a substrate.

### BACKGROUND OF THE INVENTION

Artificial stone materials such as Corian have found increasing acceptance for use with kitchen and bathroom counters and backsplashes and other areas where a hard, aesthetically appealing surface is desirable. However, such artificial stone materials are heavy and relatively expensive, and in some instances it may be difficult to create complex geometries. Therefore, it has been desirable to create coatings which can be sprayed or otherwise applied to a relatively inexpensive and/or lightweight substrate to form a hardtop with a hard, aesthetically appealing surface.

U.S. Pat. No. 5,476,895 to Ghahary teaches a sprayable coating having a thermoset gel coat, a filler and granules isopycnic (having the same density) with the gel coat. Generally it is desirable to have more filler in the coating, and less gel coat. More filler increases the strength of the material once it sets and allows for the formation of thicker hardtops, which is desirable. However, with too much filler the gel coat cannot “wet out” the filler. That is, the coating will be too thick to spray. Known coatings such as those disclosed in Ghahary are expensive and are significantly limited in the amount of filler that can be used; no more than 10-15% by weight. This means that the strength and thickness of conventional hardtop coatings is significantly limited. In addition, because known gel coats shrink, when there is too much gel coat in the coating the hardtop may pull away from a mold it is sprayed into, or cause other nonuniform distortions to the shape of the hardtop.

Ghahary also discloses compositions of coatings having liquid systems with high levels of reactive monomers, such as styrene monomer, vinyl toluene, and methylmethacrylate (MMA). Ghahary discloses reactive monomers in amounts as high as 39-40% of the total of a liquid system component of its coating, and at least greater than 17.5% of the total weight of its coating. It would be desirable to reduce the amount of reactive monomer.

U.S. Pat. No. 5,789,032 to Le Cong et al discloses a composition for post-application to a substrate which is 20-50% curable polyester resin and in excess of 45% filler. The composition of Le Cong et al is pourable, but due to the high amounts of filler and relatively low level of curable polyester resin, the composition has a thick constituency and it is not sprayable. Moreover, the resin used in Le Cong et al does not have UV stabilizers added to prevent rapid discoloration in response to sunlight and does not have thixotropic additives required to ensure smooth application over a substrate. In addition, Le Cong et al discloses application of a coating with a very high thickness, and requires extensive sanding and other secondary operations to produce a smooth hardtop surface.

It would be desirable to provide a composition of a coating which would provide high strength properties upon hardening. It would also be desirable to provide a coating of low cost which can be applied at optimum thickness with rapid and complete air release to produce a nonporous finish so that secondary operations are not required.

### SUMMARY OF THE INVENTION

In accordance with a first aspect, a coating comprises a gel coat, a filler and a ultraviolet stabilizer. Preferably the weight of filler exceeds the weight of the gel coat. The coating can be sprayed onto a substrate to form a solid surface. In accordance with another aspect, the filler is formed of small diameter elements, added as a mixture with the gel coat. In addition, preferably the coating has less than 17.5% by weight styrene monomer.

From the foregoing disclosure and the following more detailed description of various preferred embodiments it will be apparent to those skilled in the art that the present invention provides a significant advance in the technology and art of coating compositions. Particularly significant in this regard is the potential the invention affords for providing a high quality, low cost, coating which can be sprayed into a mold and/or onto a substrate to create an attractive stone-like hardtop. Additional features and advantages of various preferred embodiments will be better understood in view of the detailed description provided below.

### DETAILED DESCRIPTION OF CERTAIN PREFERRED EMBODIMENTS

It will be apparent to those skilled in the art, that is, to those who have knowledge or experience in this area of technology, that many uses and design variations are possible for the coating composition disclosed here. The following detailed discussion of various alternative and preferred features and embodiments will illustrate the general principles of the invention with reference to a coating suitable for spraying into a mold over a substrate to form an attractive, stone-like surface suitable for use as kitchen counters, bathroom counters, sidewalls and backsplashes, etc. Other embodiments suitable for other applications will be apparent to those skilled in the art given the benefit of this disclosure.

The sprayable coating comprises a gel coat, a filler, and optionally one or more pigments to color the coating. The coating has a total weight and the gel coat and filler each have a weight. Preferably the weight of the filler is 40-60% of the total weight, and more preferably the weight of the filler should exceed the weight of the gel coat. A high percentage of filler in the composition of the sprayable coating permits increased application thicknesses. It has been found that thickness of coating in the range of 21 to 50 mils is desirable, and more preferably coatings having a thickness of about 30-40 mils is preferable. Preferably for colorization, a pigment is 0-6% of the total weight of the coating. Preferably the coating is pre-applied to a mold. That is, the coating is sprayed onto a mold and allowed to cure. Next, a substrate is applied behind the coating. The substrate could comprise a solid insert or could be another sprayable material, such as a polyester and glass fiber mix.

As used herein, the term “gel coat” can comprise liquid-like matrices which permits curtain walling and the coating of panels. The gel coats preferably used are thermoset materials where the addition of a catalyst, such as organic peroxide catalyst DDM 9, shortly before application (spraying into a mold) causes the gel coat to undergo an irreversible chemical reaction and harden. Other catalysts or hardening agents suitable for use in gel coats will be readily apparent to those skilled in the art given the benefit of this disclosure.

Many known gel coats are suitable for the practice of the invention, however, a clear polyester resin is preferred. The gel coat can comprise, for example, a polyester resin comprising neopentyl glycol (NPG) and an isophthalic resin. Such resins or resin blends are available through a variety of sources, including, for example, HK Research, in Hickory, N.C., Ashland in Dublin, Ohio, and Polyguard in Tampa, Fla. Suitable polyester resins include those prepared from polymerizable unsaturated polyesters such as those prepared from ethylenically unsaturated polycarboxylic acids and polyhydric alcohols. Preferably the resin, when fully cured, provides desirable heat, chemical and moisture resistance. A preferred polyester resin includes a styrated isophthalic resin, i.e., one that contains reactive monomers, such as styrene monomers. Although the preferred resin system is comprised of an isophthalic resin, an orthophthalic and other resins may also be utilized. Other possible polymeric resins can comprise, for example, thermoset acrylics, vinyl esters, epoxy resin systems. Further, it is possible that the primary resin could be comprised of a blend or mixture of different resin components, provided that the various resin components are compatible with one another.

Importantly, the coating must incorporate an ultraviolet stabilizing agent such as Tinuvin 328, preferably about 0.25% of the total weight, to prevent the resin from yellowing upon exposure to ultraviolet radiation. Further, the coating should have a thixotropic additive such as fumed silica to avoid a tendency for the coating to run. Normally these components, along with the promoters such as cobalt napthenate ( at about 0.1% of total weight) and additives for air release such as BYK 555 (at about 0.3% of total weight) would comprise part of the gel coat.

Heretofore gel coats normally have comprised about 35-40% reactive monomer. Reactive monomers are those that cross link to polyester polymers commonly found in the aforementioned gel coats. In accordance with an advantageous feature, using less gel coat reduces the amount of reactive monomer. In some preferred embodiments the coating will contain reactive monomers in amounts less than 17.5% of the total weight of the coating, i.e., less than 50% by weight gel coat and less than 35% reactive monomer.

Known fillers are normally made in the form of precipitated crystals of aluminum trihydrate having an average diameter of about 75 microns. These precipitated crystals must then undergo a secondary grinding operation, reducing their size to 15-20 microns. This is done to increase the amount of surface area of the filler that is exposed to the gel coat, so that the gel coat can properly “wet out” the filler.

In accordance with a highly advantageous feature, the filler can comprise unground aluminum thihydrate having a diameter of less than 12 microns, and more preferably about 8 microns. Using this diameter filler advantageously eliminates the need for secondary grinding operations while simultaneously increasing the amount by weight of filler which can be added to the coating while still permitting the gel coat to wet out the filler and allow proper flow characteristics. With such a filler, the hardness of the hardtop can be increased and since there is less gel coat, shrinkage of the hardtop is reduced and the thickness of the hardtop can be increased.

As an example of one preferred embodiment suitable for use as a countertop, the mineral filler is aluminum trihydrate (ATH) and comprises 40-60% of the total weight of the coating; the gel coat comprises principally an isophthalic NPG gel coat, and the gel coat would comprise about 40-55% of the total weight, and a styrene monomer would comprise only about 45% of the weight of the gel coat. The remainder of the coating would comprise an appropriate pigment. More specifically, the gel coat can comprise less than 50% of the total weight and the filler weight would exceed the weight of the gel coat. Such a coating can be applied to a thickness of about 30-40 mils and used as a kitchen countertop wear surface. Non wear surfaces may be thinner.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A coating having a total weight comprising, in combination:
a gel coat comprising a ultraviolet stabilizer; and
a filler, wherein a weight of the filler is about 40-60% of the total weight.

2. The coating of claim 1 further comprising a pigment, wherein the pigment comprises 0-6% of the total weight.

3. The coating of claim 1 wherein the gel coat is a thermoset material.

4. The coating of claim 1 wherein the gel coat comprises an isophthalic neopentyl glycol resin.

5. The coating of claim 1 wherein the filler is aluminum trihydrate.

6. The coating of claim 1 wherein the coating has a thickness of about 21 to 50 mils.

7. The coating of claim 6 wherein the coating is sprayed onto a mold.

8. The coating of claim 7 wherein the coating is allowed to cure and a substrate is sprayed behind the coating.

9. The coating of claim 6 wherein the thickness of the coating is about 30 to 40 mils.

10. The coating of claim 1 wherein the gel coat further comprises a thixotropic agent.

11. The coating of claim 1 wherein the weight of the filler exceeds a weight of the gel coat.

12. The coating of claim 1 wherein a weight of the ultraviolet stabilizer is about 0.25% of the total weight.

13. A coating comprising, in combination:
a gel coat; and
a filler having a diameter of less than 12 microns.

14. The coating of claim 13 wherein the filler is unground and comprises precipitated crystals having a diameter of about 8 microns.

15. The coating of claim 13 wherein the filler is unground aluminum trihydrate.

16. The coating of claim 13 wherein the gel coat and filler have a total weight, and a weight of the filler is 40-60% of the total weight.

17. A coating having a total weight comprising, in combination:
a gel coat and a filler;
wherein the gel coat contains a reactive monomer in an amount less than 17.5% of the total weight.

18. The coating of claim 17 wherein the styrene monomer is greater than 15% and less than 17.5% of the total weight.

19. The coating of claim 17 where in the gel coat comprises an ultraviolet stabilizer and a thixotropic agent.
